(19) United States
(12) Patent Application Publication
(10) Pub. No.: US 2014/0325236 A1
(43) Pub. Date: Oct. 30, 2014

(54) VEHICULAR IMAGE PROCESSING APPARATUS AND DATA PROCESSING METHOD USING THE SAME

(71) Applicants: THINKWARE SYSTEMS CORPORATION, SEONGNAM-SI (KR); INTELLECTUAL DISCOVERY CO., LTD., SEOUL (KR)

(72) Inventor: Jae Sung KIM, Yongin-si (KR)

(73) Assignees: INTELLECTUAL DISCOVERY CO., LTD., SEOUL (KR); THINKWARE SYSTEMS CORPORATION, SEONGNAM-SI (KR)

(21) Appl. No.: 14/263,461

(22) Filed: Apr. 28, 2014

(30) Foreign Application Priority Data
Apr. 29, 2013 (KR) 10-2013-0047793

(51) Int. Cl. G06F 21/60; H04N 7/18

(52) U.S. Cl. CPC G06F 21/60; H04N 7/183
USPC 713/189

(57) ABSTRACT

Provided is a vehicular image processing apparatus for applying a different encryption scheme and access authority for each of a channel and a type of data with respect to an image recorded in a black box mounted in a vehicle, and a data processing method using the same.

### CROSS-REFERENCE TO RELATED APPLICATION

This application claims the priority benefit of Korean Patent Application No. 10-2013-0047793, filed on Apr. 29, 2013, in the Korean Intellectual Property Office, the disclosure of which is incorporated herein by reference.

### BACKGROUND

1. Field of the Invention

The present invention relates to a vehicular image processing apparatus and more particularly, to a vehicular image processing apparatus for encrypting an image recorded in a black box of a vehicle, based on various schemes, and a data processing method implemented by the vehicular image processing apparatus.

2. Description of the Related Art

An increasing number of vehicle owners install a black box in a vehicle to investigate a cause of a traffic accident and to minimize a dispute between parties involved in the traffic accident. In this regard, mandatory installation of a vehicular black box is recommended in numerous countries.

Image data stored in a black box mounted in each vehicle may be used for traffic flow management and thus, use of the data stored in the black box is increasing for efficient traffic control and prevention of traffic accidents.

The black box may store an event, for example, an image, a speed of a vehicle, an angle of collision, a post treatment process, and the like of an accident as an image such that the image may be used to avoid a dispute between parties involved in the accident and form a legal basis. As such, the black box may provide significant data for investigating causes of traffic accidents. Also, the black box may perform a function of a closed circuit television (CCTV) at a scene of a crime. Thus, a demand of the black box is increasing. In contrast, the black box may give rise to invasion of privacy concerns resulting from indiscriminate image dissemination and adverse effects arising due to a manipulated image. Although personal information disseminated through an image recorded in a public transportation needs to be strictly protected, data recorded in the public transportation, for example, a taxi, a bus, a subway, and the like may be easily accessed and disseminated by a driver, which may lead to an invasion of privacy and a violation of image rights.

### SUMMARY

An aspect of the present invention provides a vehicular image processing apparatus for applying a different encryption scheme and access authority for each of a channel and a type of data with respect to an image recorded by a black box mounted in a vehicle, and a data processing method using the same.

Another aspect of the present invention also provides a vehicular image processing apparatus for encrypting and storing an image and a sound to be used as evidence relating to an accident and protecting personal data by ensuring security with respect to an image recorded in a black box mounted in a vehicle, and a data processing method using the same.

According to an aspect of the present invention, there is provided a vehicular image processing apparatus mountable in a vehicle, the apparatus including a memory, a camera module to acquire an external image, a microphone to acquire an external sound, and a controller to generate black box data by selectively performing one of a first operation of encrypting only the external image, a second operation of encrypting only the external sound, and a third operation of encrypting both the external image and the external sound when the black box is to be generated by acquiring the external image and the external sound.

According to an aspect of the present invention, there is provided a data processing method using a vehicular image processing apparatus mountable in a vehicle, the method including acquiring an external image through a camera module included in the vehicular image processing apparatus, acquiring an external sound through a microphone included in the vehicular image processing apparatus, and generating black box data by selectively performing one of a first operation of encrypting only the external image, a second operation of encrypting only the external sound, and a third operation of encrypting both the external image and the external sound when the black box is to be generated by acquiring the external image and the external sound.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a vehicular image processing apparatus according to an embodiment of the present invention;

FIG. 2 is a diagram illustrating an example of various data encryption schemes according to an embodiment of the present invention;

FIG. 3 is a flowchart illustrating an example of a data processing method according to an embodiment of the present invention; and

FIG. 4 is a flowchart illustrating another example of a data processing method according to an embodiment of the present invention.

### DETAILED DESCRIPTION

Purposes, features and advantages of the present invention will clearly appear through the detailed descriptions given below with reference to the accompanying drawings. Hereinafter, exemplary embodiments are described in detail by referring to the drawings, wherein like reference numerals refer to the like elements throughout. When it is determined that a detailed description is related to a related known function or configuration which may make the purpose of the present disclosure unnecessarily ambiguous in the description, such a detailed description will be omitted.

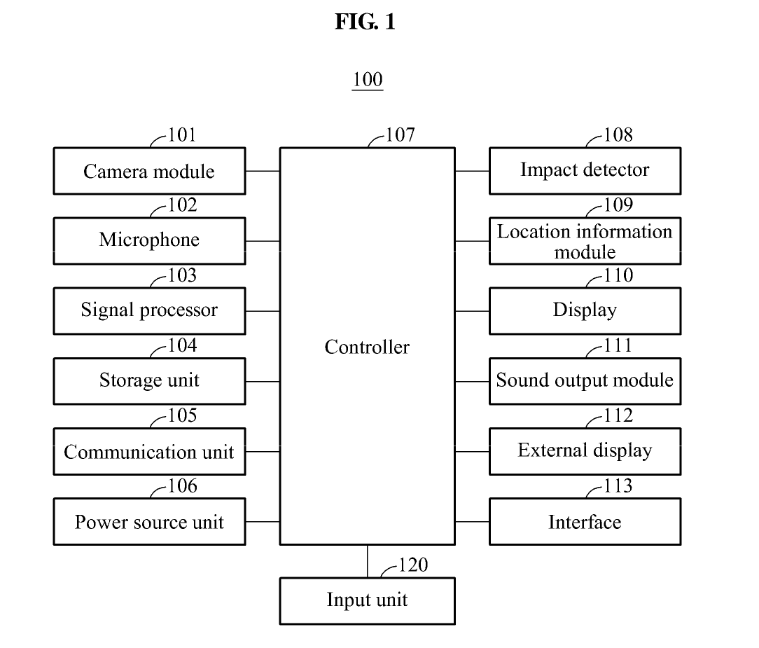

Hereinafter, a vehicular image processing apparatus according to the present invention will be described in more detail with reference to the accompanying drawings. The suffixes “module” and “unit” used for constituent elements disclosed in the following descriptions are merely intended for ease of description of the specification, and the suffixes themselves do not provide any special meaning or function. Therefore, it should be noted that the suffixes “module” and “unit” may be used interchangeably.

<FIG. 1> Configuration of Black Box

FIG. 1 is a block diagram illustrating a configuration of a vehicular image processing apparatus 100 according to an embodiment of the present invention.

The image processing apparatus 100 for a vehicle may also be referred to as a black box apparatus.

Referring to FIG. 1, the image processing apparatus 100 may include a camera module 101, a microphone 102, a signal processor 103, a storage unit 104, a communication unit 105, a power source unit 106, a controller 107, an impact detector 108, a location information module 109, a display 110, a sound output module 111, an external display 112, an interface 113, and an input unit 120.

The camera module 101 may acquire image data corresponding to at least one channel. For example, the camera module 101 may photograph a front, rear, side, or internal image of the vehicle, and transmit the photographed image to the signal processor 103. The photographed image, for example, image data may be compressed by the signal processor 103 and stored in the storage unit 104, or may be immediately stored in the storage unit 104 without being compressed. Based on a system configuration, the camera module 101 may include a single camera to photograph a front image. In a case in which the camera module 101 includes a plurality of cameras, a recording position and a target direction may be set such that each of the cameras is directed to a front, rear, side, and inside of the vehicle using various methods, based on a purpose.

The microphone 102 may acquire at least one of an external sound and an internal sound of the vehicle. For example, the microphone 102 may record a voice or a sound originating internally or externally and transmit the recorded voice or sound to the signal processor 103. The transmitted recorded voice or sound may be compressed by the signal processor 103 and stored in the storage unit 104, or may be immediately stored in the storage unit 104 without being compressed. The recorded voice or sound may relate to a sound made by an external impact, or a situation occurring internally and externally. The recorded voice or sound and the photographed image may be helpful in recognizing conditions at the time of an accident.

The signal processor 103 may perform compression to reduce a volume of image data photographed by the camera module 101. The image data may be provided in a form of a number of frames gathered based on a time axis. The image data may correspond to successive photographs captured during a provided period of time. Since a volume of such images may be overly great without compression, storing the original images in a memory may be inefficient. Thus, compression may be performed on digitally-converted images. A video may be compressed using a method using a characteristic of a vision sensitive to a low-frequency component, a spatial correlation, and a correlation between frames. Since original data may be lost due to compression, the image data may need to be compressed at a suitable ratio to verify conditions related to a vehicle at a time of a traffic accident. A video may be compressed using one of various video codecs, for example, H.264, moving picture experts group (MPEG)-4, H.263, and H.265/high efficiency video coding (HEVC). The image data may be compressed using a method supported by the vehicular image processing apparatus 100.

The signal processor 103 may compress data recorded by the microphone 102. The signal processor 103 may compress and encode the recorded image and audio data to restrict access to the data.

The storage unit 104 may store the recorded image and audio data as a single file or two files based on a storage period. For example, when the storage period corresponds to 30 seconds, an image and a sound recorded for the first 30 seconds may be compressed and stored as a video file, and an image and a sound recorded for another 30 seconds may be continuously compressed and stored.

The storage unit 104 may store different types of data in different storage areas partitioned based on a recording mode. For example, data recorded during driving and data recorded during parking may be stored in different folders, and data recorded at ordinary times and data recorded by an event may be stored in different folders.

The storage unit 104 may be provided in an internal portion of the vehicular image processing apparatus 100, provided to be detachable through a port provided in the vehicular image processing apparatus 100, or provided in an external portion of the vehicular image processing apparatus 100. When the storage unit 104 is provided in the internal portion of the vehicular image processing apparatus 100, the storage unit 104 may be provided in a form of a disk drive or a flash memory. When the detachable storage unit 104 is provided in the vehicular image processing apparatus 100, the storage unit 104 may be provided in a form of a secure digital (SD) card, a micro SD card, or a universal serial bus (USB) memory. When the storage unit 105 is provided in the external portion of the vehicular image processing apparatus 100, the storage unit 105 may be present in another device or a storage space of a server through the communication unit 105.

The communication unit 105 may configure a connection between the vehicular image processing apparatus 100 and a server, another vehicle, or another device to exchange a recorded image or sound. In addition, the communication unit 105 may enable vehicular information or environmental information to be transmitted to and received from the server, the other vehicle, or the other device. The communication unit 105 may support wireless networks, for example, wireless-fidelity (Wi-Fi), Bluetooth, third generation (3G), long-term evolution (LTE), worldwide interoperability for microwave access (WiMAX), and wireless gigabit alliance (WiGig), and wired networks, for example, Ethernet, and a modulator-demodulator (MODEM).

The power source unit 106 may receive a power from an external power source or an internal battery, and supply operational power to the vehicular image processing apparatus 100. When a vehicle is started, a power of the vehicle may be applied to the vehicular image processing apparatus 100 to charge a chargeable battery thereof. When an engine of the vehicle is stopped, the power of the rechargeable battery may be supplied to the vehicular image processing apparatus 100.

The controller 107 may generally control an overall operation of the vehicular image processing apparatus 100. The controller 107 may include a multimedia module to play back multimedia data. The multimedia module may be included in the controller 107, or provided separately from the controller 107.

The controller 107 may set an operating mode of the vehicular image processing apparatus 100 based on a signal of the impact detector 108 or whether the vehicle is travelling. The controller 107 may perform an ordinary recording function while the vehicle is travelling, and perform an event recording function when an impact event is detected by the impact detector 108. The controller 107 may control the vehicular image processing apparatus 100 to perform a parking recording function by determining the impact event detected by the impact detector 108 or a movement of an object recorded by the camera module 101 while the vehicle is being parked.

When an impact applied to the vehicle is detected or a change in an acceleration is greater than or equal to a predetermined level, the impact detector 108 may generate a signal corresponding to the event, for example the accident event, and transmit the generated signal to the controller 107. The impact detector 108 may include an acceleration sensor, and an earth magnetic field sensor to detect an impact or an acceleration.

The location information module 109 may correspond to a module to verify or obtain a location of the vehicular image processing apparatus 100. A representative example of the location information module is a global positioning system (GPS) module.

The location information module 109 may continuously calculate a current location of the vehicle in real time, and calculate speed information of the vehicle based on calculated locations.

The display 110 may display or output information processed by the vehicular image processing apparatus 100.

For example, the display 110 may enable the image and sound recorded by the camera module 101 to be displayed in real time or at a desired time. The display 110 may display recording settings to be easily set by the controller 107, and may enable a user to easily select and set a desired function through a touch input.

The display 110 may include at least one of a liquid crystal display (LCD), a thin film transistor-liquid crystal display (TFT LCD), an organic light emitting diode (OLED), a flexible display, and a three-dimensional (3D) display.

In a case in which the display 110 and a sensor configured to sense a touch motion, hereinafter, referred to as a “touch sensor”, are provided in a form of a mutual layer, hereinafter, simply referred to as a “touch screen”, the display 110 may be used as both an input device and an output device. The touch sensor may be provided in a form of, for example, a touch film, a touch sheet, and a touch pad.

The sound output module 111 may output audio data received by the communication unit 105 or stored in the storage unit 104. The sound output module 111 may output an audio signal related to a function performed by the vehicular image processing apparatus 100.

The sound output module 111 may include a receiver, a speaker, and a buzzer. The sound output module 111 may output a sound through an earphone jack. A user may connect an earphone to the earphone jack, and hear an output sound.

The external display 112 may refer to a light emitting device, for example, a light emitting diode (LED), and a light. The external display 112 may inform about an operating state of the vehicular image processing apparatus 100, or may provide a light for an easy control of the vehicular image processing apparatus 100, for example, a button or a touch.

The interface 113 may act as a bridge between the vehicular image processing apparatus 100 and all external devices to be connected to the vehicular image processing apparatus 100. The interface 113 may receive data or a power from an external device and transfer the data or the power to each constituent element of the vehicular image processing apparatus 100, or may enable internal data of the vehicular image processing apparatus 100 to be transmitted to an external device. For example, the interface 113 may include a wired/wireless headset port, an external charger porter, a wired/wireless data port, a memory card port, a port configured to connect a device including an identification module, an audio input/output (I/O) port, a video I/O port, and an earphone port.

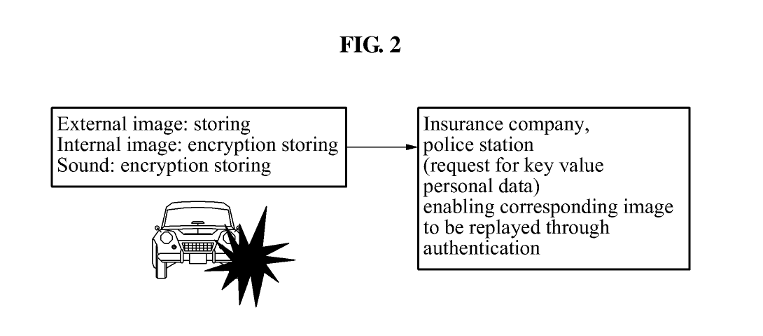

A user may generate input data to control an operation of the vehicular image processing apparatus 100 through the input unit 120. The input unit 120 may include a key pad, a dome switch, a resistive/capacitive touch pad, a jog wheel, and a jog switch.

<FIG. 2> Encryption of Recorded Image

Only an authenticated organization or individual may be allowed to read an internal sound or image stored through encryption.

FIG. 2 is a diagram illustrating an example of various data encryption schemes according to an embodiment of the present invention.

In a constant record mode, the vehicular image processing apparatus 100, for example, a black box may continuously sense a sound input through a microphone while storing a recorded image without encrypting.

When the sound is sensed in a process of recording, the vehicular image processing apparatus 100 may store data by encrypting the sound sensed during a corresponding interval.

For example, data storing may be set to be performed every five minutes in the constant record mode. When a sound is not input during an interval A indicating a first five-minute interval, a recorded image may be stored without being encrypted. When a sound input is sensed at a point in time subsequent to three minutes elapsing from a starting point of an interval B indicating a subsequent five-minute interval, an image recorded during the interval B may be stored through encryption.

When an input is received from various channels, for example, a front camera, a rear camera, a side camera, an internal camera, and the like, the vehicular image processing apparatus 100 may store an external image and sound without encryption, and store an internal image and sound through encryption. Only a user having a corresponding encryption key may replay the encrypted internal image and the internal sound. For example, the controller 107 encrypt at least one of image data corresponding to at least one channel and audio data corresponding to at least one channel, based on a type of data indicating whether each channel corresponds to an internal area or an external area of a vehicle. As another example, the controller 107 may encrypt internal audio data corresponding to a channel used to acquire a sound originating from the internal area of the vehicle among the audio data corresponding to the at least one channel.

In addition, when an input is received from various channels, for example, a front camera, a rear camera, a side camera, an internal camera, and the like, the vehicular image processing apparatus 100 may store images of all channels without encryption, and store sounds of all channels through encryption. Only a user having an encryption key may replay the encrypted images of all channels and the encrypted sounds of all channels corresponding to the encryption key.

Also, the recorded image encrypted and stored using the vehicular image processing apparatus 100 may only be replayed by an authenticated user, and the encrypted and stored sound may only be replayed when an encryption key is provided by an authenticated organization, thereby enhance a security for the sound.

With respect to a sound input to the vehicle image processing apparatus 100, an audio signal corresponding to a predetermined frequency band may be stored through encryption, and remaining audio data may or may not be stored. For example, the controller 107 may encrypt an audio signal corresponding to a predetermined frequency band among the audio data corresponding to the at least one channel.

Through sound recognition, a setting for encrypting and storing only a sound including a predetermined word among the sound input to the vehicle image processing apparatus 100 may be allowed. For example, through sound recognition, the controller 107 may encrypt an audio signal corresponding to a portion in which a predetermined word is recognized, among the audio data corresponding to the at least one channel.

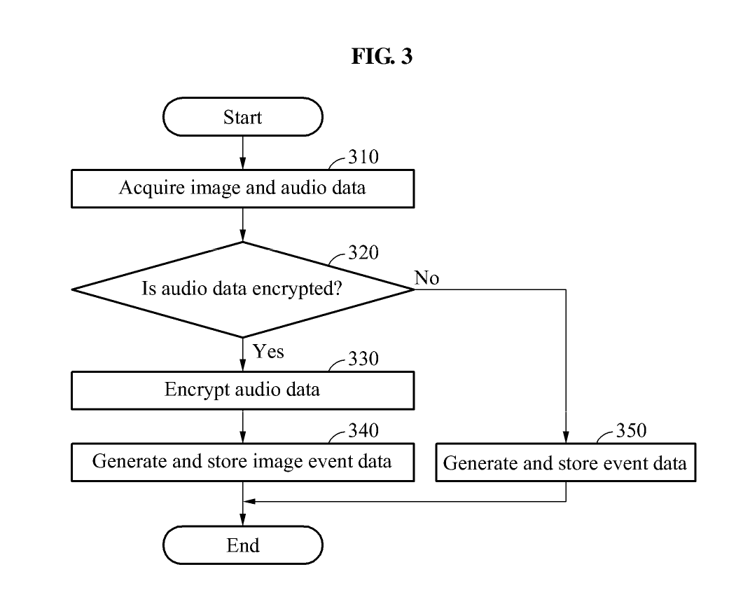

FIG. 3 is a flowchart illustrating an example of a data processing method according to an embodiment of the present invention. The data processing method of FIG. 3 may be implemented by the vehicular image processing apparatus 100 of FIG. 1. Hereinafter, the data processing method of FIG. 3 and operations of the vehicular image processing apparatus 100 for implementing the data processing method of FIG. 3 will be described in detail with reference to the drawings.

Referring to FIG. 3, in operation 310, the controller 107 may acquire image data and audio data. In operation 320, the controller 107 may determine whether an input, regarding whether audio data to be encrypted, is received from a user. For example, whether an encryption execution signal for the audio data is input by the user may be determined.

When the user inputs the encryption execution signal for the audio data, the controller 107 may encrypt the audio data in operation 330. Subsequently, in operation 340, the controller 107 may generate image event data by combining the encrypted audio data and image data and encoding a result of the combining, and then store the generated image event data.

When the user does not input the encryption execution signal for the audio data, the controller 107 may generate event data by combining the image data and the audio data on which an encryption is not performed, and encoding a result of the combining, and then store the generated event data in operation 350.

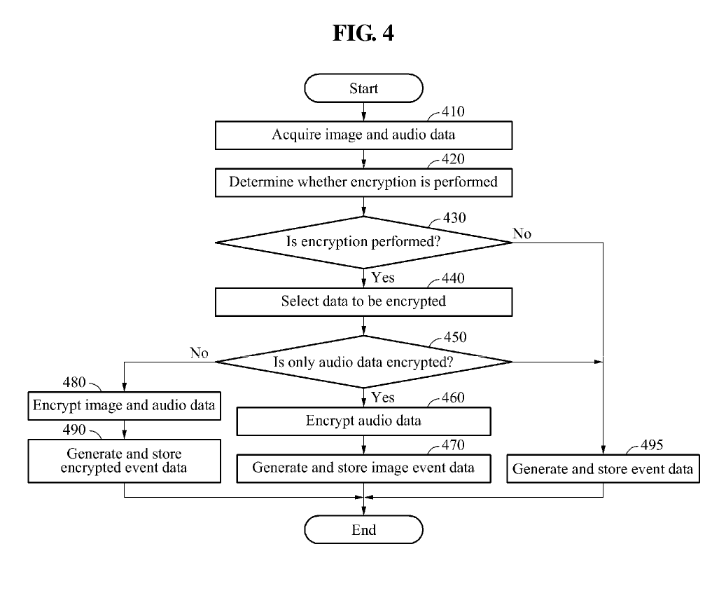

FIG. 4 is a flowchart illustrating another example of a data processing method according to an embodiment of the present invention. The data processing method of FIG. 4 may be implemented by the vehicular image processing apparatus 100 of FIG. 1. Hereinafter, the data processing method of FIG. 4 and operations of the vehicular image processing apparatus 100 for implementing the data processing method of FIG. 4 will be described in detail with reference to the drawings.

Referring to FIG. 4, in operation 410, the controller 107 may acquire image data and audio data. In operation 420, the controller 107 may be input, by a user, a selecting signal for determining whether an encryption is to be performed on the audio data.

In operation 430, the controller 107 may determine whether the selecting signal input in operation 410 corresponds to an encryption execution signal of the audio data.

When the user does not input the encryption execution signal of the audio data, the controller 107 may generate event data by combining the image data and the audio data on which an encryption is not performed, and encoding a result of the combining, and then store the generated event data in operation 495

When the user inputs the encryption execution signal of the audio data, the controller 107 may input, by the user, a selecting signal for data to be encrypted between the image data and the audio data in operation 440. For example, the controller 107 may generate black box data by encrypting at least one of image data corresponding to at least one channel and audio data corresponding to at least one channel, based on a predetermined encryption level of each channel.

In operation 450, the controller 107 may determine whether the selecting signal input in operation 440 is a signal instructing encryption of the audio data. When the selecting signal is the signal instructing the encryption of the audio data, the controller 107 may encrypt the audio data in operation 460. In operation 470, by combining the encrypted audio data and the image data and encoding a result of the combining, the controller 107 may generate image event data and store the generated event data. For example, the black box data may include the image event data.

When the selecting signal is a signal instructing encryption of the image data and the audio data, the controller 107 may encrypt the image data and the audio data in operation 480. In operation 490, by combining the encrypted image data and the encrypted audio data and encoding a result of the combining, the controller 107 may generate encrypted event data and store the generated encrypted event data.

Hereinafter, descriptions about a method of determining an encryption level by classifying a data protection level based on a degree of necessity to protect personal data will be provided.

Based on a location in which a black box, for example, the vehicular image processing apparatus 100 is installed and utilized, recorded image and sound may be stored with a corresponding encryption level. The stored image and sound may be read by only an authenticated individual or organization.

An example of classifying the data protection level based on a degree of necessity to protect personal data with respect to stored data may be described as shown in Table 1.

TABLE 1

| | | | Encryption | Publicity |
|---|---|---|---|---|
| Purpose | Type of data | Details on black box type | level | identifier |
| Privately | External | Channel 1 front image | Non- | Private |
| owned | image data | Channel 2 front/rear images | encryption | |
| vehicle | | Channel 3 front/rear images | | |
| | | Channel 4 front/rear/side images | | |
| | Internal | Channel 2/channel 3 internal | Level 1 | Private |
| | image data | images | | |
| | Audio data | Common | Level 2 | Private |
| Public | External | Channel 1 front image | Non- | Public |
| transportation | image data | Channel 2 front/rear images | encryption | |
| vehicle | | Channel 3 front/rear images | | |
| | | Channel 4 front/rear/side images | | |
| | Internal | Channel 2/channel 3 internal | Level 3 | Public |
| | image data | images | | |
| | Audio data | Common | Level 4 | Public |

In the encryption level, the level 1 may correspond to the lowest level of data protection levels, and a security may be enhanced according to an increase in the level. For example, an encryption difficulty level of a predetermined encryption level may be determined based on the data protection level.

A purpose of the black box may be classified into a use in a privately owned vehicle and a use in a public transportation vehicle, based on a location at which the black box is installed and utilized. A publicity identifier may be used to classify respective purposes. For example, the encryption level may be previously determined for each channel based on a publicity identifier corresponding to a purpose of the vehicular image processing apparatus.

When the publicity identifier is “public”, a basic encryption level may be increased by “2” as a weighted value, thereby achieve a higher level.

When the external image data is determined to be unnecessary for data protection, encryption may not be applied without distinction of the purpose.

By determining the purpose of the black box and an installation location of each channel, the encryption level may be determined for each channel using a user setting function. For example, the encryption level of each channel may be previously determined based on a location at which image data corresponding to at least one channel and audio data corresponding to at least one channel are acquired. As another example, the controller 107 may determine whether image data input through each of a plurality of cameras is encrypted, based on a target direction of each of the plurality of cameras corresponding to the at least one channel.

When encrypted data is to be read, an authentication level may be determined based on an allowance level of handling personal data, and then an encryption level available to be read may be determined for each level based on a handling policy.

As shown in Table 2, the authentication level may include three levels, a master, a public, and a private. The master may correspond to the highest level, the public level may correspond to an intermediate level, and the private may correspond to the lowest level. For example, a predetermined encryption level may be set such that a channel allowed to be read from an encrypted black box data is determined based on the authentication level.

TABLE 2

| | | Reading | | |
|---|---|---|---|---|
| | | allowed | Key | |
| Authentication | Encryption | encryption | required for | Authenticated |
| level | allowed level | level | reading | entity |
| Master | None | 1, 2, 3, 4 | Master key | Legal |
| | | | | enforcement |
| | | | | organization |
| Public | 1, 2 | None | Master key | Transportation |
| | | | | business |
| Private | 3, 4 | 3, 4 | Private key | Individual |

The private key may be assigned to only an individual such that other people are not allowed to read an image encrypted using a corresponding private key.

To generate a legal effect with respect to image or audio data encrypted using the private key, an image may need to be decrypted using the master key which is assigned to a corresponding organization.

The public key may be used for encryption, and reading may be allowable only through a corresponding organization to which the master key is assigned.

The master key may be used to read data encrypted using the public key and the private key while not being used for encryption.

When the data encrypted using the public key and the private key is decrypted using the master key, a series of watermark information such as “certificated” may be recorded.

An example of a type of data to be encrypted and a method of encrypting in a case of storing data in the black box may be described as shown in Table 3.

TABLE 3

| Range of | | |
|---|---|---|
| encryption | Data to be encrypted | Conditions for storage |
| Overall | All data (image + sound) | |
| encryption | All images | |
| | All sounds | |
| Partial | Portion of images | |
| encryption | Portion of sounds | Encrypt sound of |
| | | predetermined frequency |
| | | band Encrypt sound |
| | | including predetermined |
| | | word through |
| | | sound recognition |
| Non- | | |
| encryption | | |

To reduce a volume of data to be stored in the black box, a method of storing data through encryption may be provided in a form of partially encrypting a predetermined point in time.

An algorithm used for encryption may be an algorithm of various generally known patterns.

According to an aspect of the present invention, it is possible to provide a vehicular image processing apparatus and a data processing method using the same.

According to another aspect of the present invention, it is possible to protect a privacy by allowing a limited access to an image and a sound recorded by a black box mounted in a vehicle through partial and overall encryption, and ensure an integrity of the image in an event of an accident, thereby enhancing an effectiveness of the image as an evidence.

The data processing method according to the above-described exemplary embodiments of the present invention may be recorded in computer-readable media including program instructions to implement various operations embodied by a computer.

The data processing method may be executed as software. The elements of the present invention can be code segments which execute necessary tasks if the present invention is executed as software. Programs or code segments may be stored in a processor-readable medium or may be transmitted by a computer data signal combined with a carrier wave over a transmission medium or communication network.

The computer-readable media include any data storage device that can store data which can thereafter be read by a computer system. Examples of the computer-readable recording medium include read-only memories (ROMs), random-access memories (RAMs), compact disk (CD)-ROMs, digital video disk (DVD)-ROMs, DVD-RAMs, magnetic tapes, floppy disks, hard disks, and optical data storage devices. In addition, the computer-readable media may be distributed to computer systems over a network, in which computer-readable codes may be stored and executed in a distributed scheme

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims. The present invention is not limited to the above-described exemplary embodiments, but the entirety or part of the exemplary embodiments may be selectively combined to make various modifications.

What is claimed is:

1. A vehicular image processing apparatus mountable in a vehicle, the apparatus comprising:
a camera module to acquire image data corresponding to at least one channel;
a microphone to acquire audio data corresponding to at least one channel; and
a controller, based on a predetermined encryption level of each channel, to generate black box data by encrypting at least one of the image data corresponding to the at least one channel, and the audio data corresponding to the at least one channel.

2. The apparatus of claim 1, wherein the predetermined encryption level is determined for each channel based on a location at which the image data corresponding to the at least one channel and the audio data corresponding to the at least one channel are acquired.

3. The apparatus of claim 1, wherein the controller encrypts at least one of the image data corresponding to the at least one channel and the audio data corresponding to the at least one channel, based on a type of data indicating whether each channel corresponds to an internal area or an external area of the vehicle.

4. The apparatus of claim 1, wherein the controller encrypts internal audio data corresponding to a channel used to acquire a sound occurring in an internal area of the vehicle among the audio data corresponding to the at least one channel.

5. The apparatus of claim 1, wherein the camera module comprises a plurality of cameras corresponding to at least one channel, and
wherein the controller determines whether image data input through each of the plurality of cameras is encrypted, based on a target direction of each of the plurality of cameras corresponding to the at least one channel.

6. The apparatus of claim 1, wherein the predetermined encryption level is determined for each channel based on a publicity identifier corresponding to a purpose of the vehicular image processing apparatus.

7. The apparatus of claim 1, wherein the controller encrypts an audio signal corresponding a predetermined frequency band from the audio data corresponding to the at least one channel.

8. The apparatus of claim 1, wherein the controller encrypts an audio signal corresponding to a portion in which a predetermined word is recognized from the audio data corresponding to the at least one channel through sound recognition.

9. The apparatus of claim 1, wherein, in the predetermined encryption level, an encryption difficulty level is determined based on a data protection level.

10. The apparatus of claim 1, wherein the predetermined encryption level is set such that a channel allowed to be read from the generated black box data is determined based on an authentication level.

11. A data processing method implemented by a vehicular image processing apparatus mountable in a vehicle, the method comprising:
acquiring image data corresponding to at least one channel;
acquiring audio data corresponding to at least one channel; and
generating, based on a predetermined encryption level of each channel, black box data by encrypting at least one of the image data corresponding to the at least one channel, and the audio data corresponding to the at least one channel.

12. The method of claim 11, wherein the predetermined encryption level is determined for each channel based on a location at which the image data corresponding to the at least one channel and the audio data corresponding to the at least one channel are acquired.

13. The method of claim 11, wherein the generating comprises encrypting at least one of the image data corresponding to the at least one channel and the audio data corresponding to the at least one channel, based on a type of data indicating whether each channel corresponds to an internal area or an external area of the vehicle.

14. The method of claim 11, wherein the generating comprises encrypting internal audio data corresponding to a channel used to acquire a sound occurring in an internal area of the vehicle among the audio data corresponding to the at least one channel.

15. The method of claim 11, wherein the generating comprises determining whether image data input using each of a plurality of cameras is to be encrypted, based on a target direction of each of the plurality of cameras corresponding to the at least one channel.

16. The method of claim 11, wherein the predetermined encryption level is determined for each channel based on a publicity identifier corresponding to a purpose of the vehicular image processing apparatus.

17. The method of claim 11, wherein the generating comprises encrypting an audio signal corresponding to a predetermined frequency band from the audio data corresponding to the at least one channel.

18. The method of claim 11, wherein the generating comprises encrypting an audio signal corresponding to a portion in which a predetermined word is recognized from the audio data corresponding to the at least one channel through sound recognition.

19. The method of claim 11, wherein, in the predetermined encryption level, an encryption difficulty level is determined based on a data protection level.

20. The method of claim 11, wherein the predetermined encryption level is set such that a channel allowed to be read from the generated black box data is determined based on an authentication level.
